(19) United States
(12) Patent Application Publication
(10) Pub. No.: US 2006/0066972 A1
(43) Pub. Date: Mar. 30, 2006

(54) Read channel for simultaneous multiple bit data transfers

(75) Inventor: Charles W. Martin, Wind Gap, PA (US)

Correspondence Address: KINNEY & LANGE, PA, THE KINNEY & LANGE BUILDING, 312 SOUTH 3RD STREET, MINNEAPOLIS, MN, 55415, US

(73) Assignee: Agere Systems Inc., Allentown, PA (US)

(21) Appl. No.: 10/954,600

(22) Filed: Sep. 30, 2004

(51) Int. Cl. G11B 5/09; G11B 5/02

(52) U.S. Cl. 360/46; 360/67; 360/68

(57) ABSTRACT

A system is provided that has the ability to perform simultaneous parallel read and write operations with a plurality of transducing heads that transduce data with a storage medium. The system includes a preamplifier circuit and a read channel. The read channel includes a serializer circuit coupled to the preamplifier circuit to receive parallel data-signals and convert those signals into a serial data signal that is provided to a read channel core/controller. The read channel also includes a deserializer circuit coupled to the preamplifier circuit that converts serial write control signals from the read channel core/controller into parallel write control signals that are transmitted to the preamplifier circuit for controlling write operations.

### BACKGROUND OF THE INVENTION

The present invention relates to a read channel system that accommodates data reads and writes with multiple transducers.

There is a constant desire in the electronic data storage industry to increase the capacity and/or throughput of data storage systems. These increases have historically been achieved by increasing the density at which data is stored on a medium, increasing the rate at which data is accessed from the medium (such as by increasing the rotational speed of a disk drive spindle), or by making other improvements in the manner of transducing data. These improvements usually require significant development time and effort, and result in incremental advances over the previous state of the art.

Additional improvements to the state of the electronic data storage art would be useful.

### BRIEF SUMMARY OF THE INVENTION

The present invention is a system having the ability to perform simultaneous parallel read and write operations with a plurality of transducing heads that transduce data with a storage medium. The system includes a preamplifier circuit and a read channel. The read channel includes a serializer circuit coupled to the preamplifier circuit to receive parallel data signals and convert those signals into a serial data signal that is provided to a read channel core/controller. The read channel also includes a deserializer circuit coupled to the preamplifier circuit that converts serial write control signals from the read channel core/controller into parallel write control signals that are transmitted to the preamplifier circuit for controlling write operations.

### BRIEF DESCRIPTION OF THE DRAWINGS

FIG. 1 is a block diagram of an existing electronic data storage system.

FIG. 2 is a block diagram of an electronic data storage system according to an embodiment of the present invention, having the ability to perform simultaneous parallel read and write operations.

### DETAILED DESCRIPTION

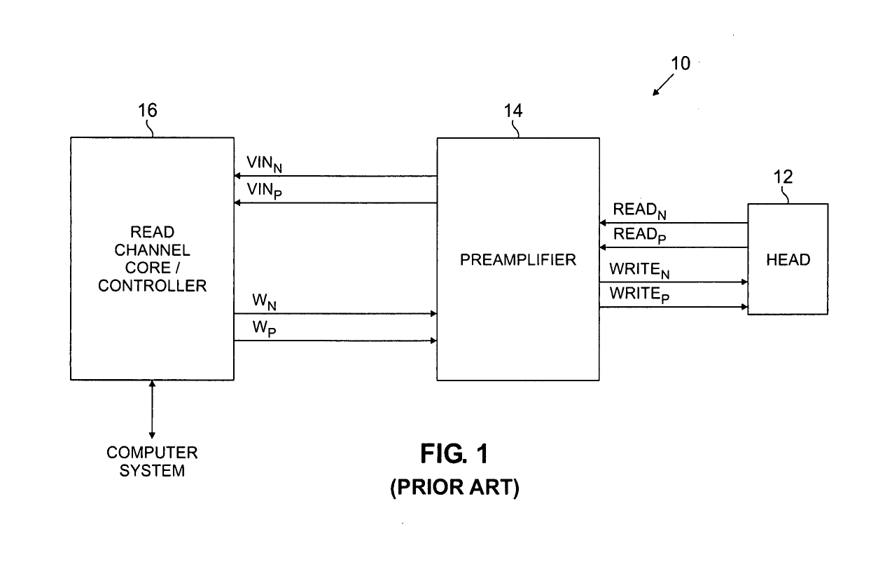

FIG. 1 is a block diagram of existing electronic data storage system 10. Electronic data storage system 10 includes transducing head 12, preamplifier 14, and read channel core/controller 16. In most electronic data storage systems of a type similar to system 10 shown in FIG. 1, a plurality of heads are employed, with a head being positioned adjacent to a top surface and a bottom surface of a plurality of rotatable disks. These multiple heads are coupled to preamplifier 14 for reading and writing operations, and one of the programmable parameters of preamplifier 14 is head selection. Only single head 12 is illustrated in FIG. 1 because of the fact that even in these multiple head systems, preamplifier 14 is only capable of receiving serial data (and passing the serial data to read channel core/controller) from a single head at a time, so that only a single head is operating to read data or write data at a given time.

In a read operation, head 12 retrieves encoded data from a medium such as a disk, and provides a differential read signal (designated in FIG. 1 as signals READ_{N} and READ_{P}) to preamplifier 14. Preamplifier 14 buffers and processes the differential read signal to provide a differential serial data signal (designated in FIG. 1 as signals VIN_{N} and VIN_{P}) to read channel core/controller 16. Read channel core/controller 16 interprets the serial data signal to provide information to a computer system or another type of system that operates with electronic data storage system 10.

In a write operation, a computer system operating with electronic data storage system 10 provides an instruction to store data, which is received by read channel core/controller 16. Read channel control/controller 16 processes the instruction and generates a differential write control signal (designated in FIG. 1 as signals W_{N} and W_{P}) that is provided to preamplifier 14. Preamplifier 14 operates on the write control signal and produces a differential signal (designated in FIG. 1 as signals WRITE_{N} and WRITE_{P}) to control head 12 to write the desired data on the medium.

Electronic data storage system 10 operates in a purely serial manner. Read channel core/controller 16 is designed to interpret serial read data from preamplifier 14. Preamplifier 14 supplies read data from each transducing head (such as head 12) to read channel core/controller 16 in a serial manner. Read channel core/controller 16 generates only serial write control signals for transmission to preamplifier 14. Preamplifier 14 then performs write operations in a serial manner as well, sending serial write data to one selected head (such as head 12) at a time.

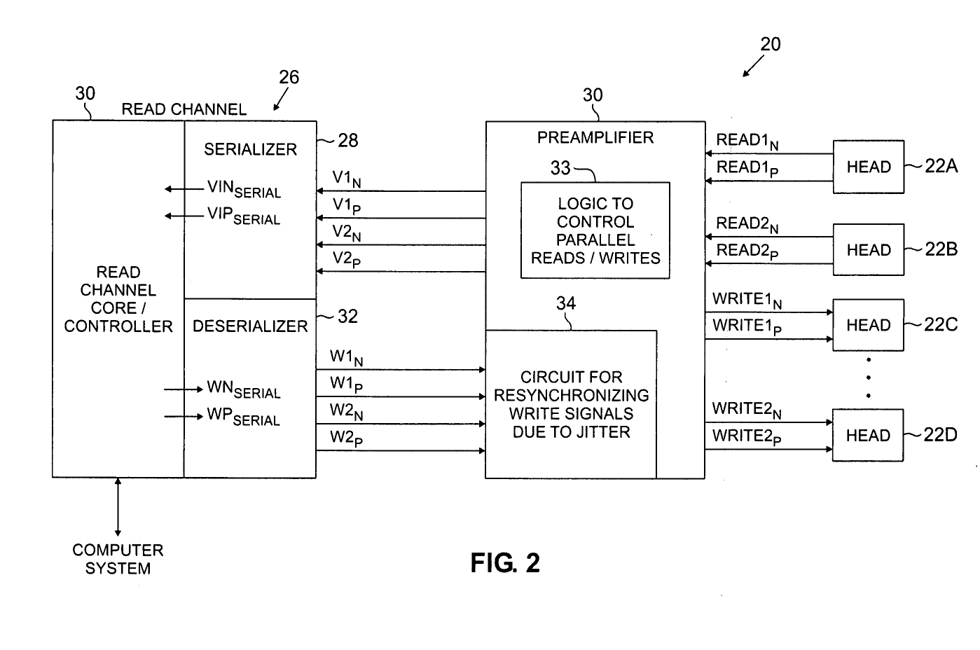

FIG. 2 is a block diagram of electronic data storage system 20 according to an embodiment of the present invention. Electronic data storage system 20 includes transducing heads 22A, 22B, 22C and 22D, preamplifier 24, and read channel 26 which includes serializer 28, read channel core/controller 30 and deserializer 32. While only four transducing heads 22A, 22B, 22C and 22D are shown in FIG. 2, it will be understood by those skilled in the art that any number of transducing heads may be employed in electronic data storage system 20.

Electronic data storage system 20 is similar to electronic data storage system 10 shown in FIG. 1, except that system 20 is configured to perform simultaneous parallel read and write operations. This capability is provided by adding serializer 28 and deserializer 32 to read channel 26, by adding logic 33 to preamplifier 24 to control parallel reads and write, and by adding circuit 34 to preamplifier 24 for resynchronizing write signals due to jitter.

In a read operation, one or more of heads 22A, 22B, 22C and 22D retrieve encoded data from a medium such as a disk, providing differential read signals to preamplifier 24. For purposes of clarity, FIG. 2 illustrates heads 22A and 22B as only performing a read operation, and heads 22C and 22D as only performing a write operation, although one skilled in the art will recognize that any head of system 20 is capable of performing either read or write operations. Head 22A provides differential signals READ1_{N} and READ1_{P}, and head 22B provides differential read signals READ2_{N} and READ2_{P}. Preamplifier 24 buffers and processes the differential read signals, under the control of logic circuit 33, to provide parallel differential data signals V1_{N} and V1_{P}, and V2_{N} and V2_{P} to serializer 28 of read channel 26. Serializer 28 converts the parallel data signals into serial data signals VIN_{SERIAL} and VIP_{SERIAL} and performs phase error correction. Serial data signals VIN_{SERIAL} and VIP_{SERIAL} are then provided to read channel core/controller 30 to be interpreted to provide information to a computer system employing electronic data storage system 10 in the conventional manner.

In a write operation, a computer system operating with electronic data storage system 20 provides an instruction to store data, which is received by read channel core/controller 30. Read channel core/controller 30 processes the instruction and generates a differential write control signal (designated in FIG. 2 as signals WN_{SERIAL} and WP_{SERIAL}) that is provided to deserializer 32. Deserializer 32 converts the serial differential control signal into parallel differential signals for controlling the appropriate heads, designated in FIG. 2 as signals W1_{N} and W1_{P}, and W2_{N} and W2_{P}. These parallel differential signals are received by preamplifier 24, which employs circuit 34 to resynchronize the write signals due to jitter, employs logic circuit 33 to properly control the multiple parallel write operations, and processes the write control signals in the conventional manner. The result of these operations is a number of parallel write signals that are simultaneously delivered to heads 22C and 22D, designated in FIG. 2 as WRITE1_{N} and WRITE1_{P}, and WRITE2_{N}and WRITE2_{P}.

The use of serializer 28 and deserializer 32 in read channel 26 allows read channel core/controller 30 to be essentially the same as read channel core/controller 16 used in previous systems, since the read signals input to read channel core/controller 30 are input serially (VIN_{SERIAL} and VIP_{SERIAL}) and the write control signals output by read channel core/controller 30 are output serially (WN_{SERIAL} and WP_{SERIAL}). The conversion of signals and the control of the system to perform multiple simultaneous parallel read and write operations is provided by merely adding appropriate logic 33 and synchronizing circuitry 34 to preamplifier 24, and by adding serializer 28 and deserializer 32 to the front end of read channel 26.

There are a number of different ways that serializer 28 and deserializer 32 may be realized in electronic data storage system 20. These circuits may be integrated into a new read channel integrated circuit (IC), may be formed as a stacked, silicon-on-silicon IC (employing a conventional read channel core/controller IC electrically interconnected to the serializer and deserializer IC), or may be formed as a completely separate IC with pins that connected to appropriate pins of the read channel core/controller IC.

The ability of the present invention to perform multiple simultaneous read and write operations provides increased throughput that can result in a number of advantages in an electronic data storage system such as a disk drive. For example, spindle speeds can be reduced while achieving the same data rates, providing the opportunity to save power and use less expensive spindle motors and controllers. Alternatively, higher data rates can be obtained at current spindle speeds, without changing existing preamplifier and read channel core technologies. Moreover, this ability is provided with a single, share read channel core, and is therefore achieved adding substantial expense.

Although the present invention has been described with reference to preferred embodiments, workers skilled in the art will recognize that changes may be made in form and detail without departing from the spirit and scope of the invention.

1. A system for performing simultaneous read and write operations with a plurality of transducing heads for transducing data with a storage medium, the system comprising:
a preamplifier circuit for coupling to the plurality of transducing heads, the preamplifier circuit being operable to:
receive read signals from the plurality of transducing heads;
transmit parallel data signals representing the read signals received from the plurality of transducing heads;
receive parallel write control signals; and
transmit write signals to the plurality of transducing heads, the write signals being based on the write control signals received; and
a read channel comprising:
a serializer circuit coupled to the preamplifier circuit to receive the parallel data signals and convert those signals into a serial data signal;
a read channel core/controller for interpreting the serial data signal and for providing a serial write control signal; and
a deserializer circuit coupled to the read channel core/controller to convert the serial write control signal into the parallel write control signals that are transmitted to the preamplifier circuit.

2. The system of claim 1, wherein the preamplifier circuit includes logic circuitry for controlling the simultaneous read and write operations of the plurality of transducing heads.

3. The system of claim 1, wherein the preamplifier circuit includes circuitry for resynchronizing the parallel write signals received from the deserializer circuit of the read channel to account for jitter.

4. The system of claim 1, wherein the serializer circuit and the deserializer circuit are implemented in a first integrated circuit and the read channel core/controller is implemented in a second integrated circuit coupled to the first integrated circuit.

5. The system of claim 4, wherein the first integrated circuit is stacked on the second integrated circuit.

6. The system of claim 1, wherein the serialize circuit, the deserializer circuit and the read channel core/controller are all implemented in a single integrated circuit.

7. A method of performing simultaneous parallel read operations in an electronic data storage system, comprising:
receiving parallel read signals from a plurality of transducing heads that read data from a medium;
providing parallel data signals representing the read signals received from the plurality of transducing heads;
converting the parallel data signals into a serial data signal;
interpreting the serial data signal to recover information stored on the medium.

8. The method of claim 7, wherein the steps of receiving parallel read signals from the plurality of transducing heads and providing parallel data signals representing the read signals received from the plurality of transducing heads are performed by a preamplifier circuit.

9. The method of claim 7, wherein the steps of converting the parallel data signals into the serial data signal and interpreting the serial data signal to recover information stored on the medium are performed by a read channel circuit.

10. The method of claim 9, wherein the step of interpreting the serial data signal to recover information stored on the medium is performed by a read channel core, and the step of converting the parallel data signals into the serial data signal is performed by a serializer circuit coupled to the read channel core.

11. The method of claim 7, further comprising:
controlling reception of the parallel read signals from a plurality of transducing heads with logic circuitry.

12. A method of performing simultaneous parallel write operations in an electronic data storage system, comprising:
generating a serial write control signal based on a write command;
converting the serial write control signal into parallel write control signals;
transmitting write signals to a plurality of transducing heads, the write signals driving the transducing heads to write data to a medium and being based on the parallel write control signals.

13. The method of claim 12, wherein the steps of generating the serial write control signal and converting the serial write control signal into parallel write control signals are performed by a read channel circuit.

14. The method of claim 13, wherein the step of generating the serial write control signal based on a write command is performed by a read channel core/controller, and the step of converting the serial write control signal into parallel write control signals is performed by a deserializer circuit coupled to the read channel core/controller.

15. The method of claim 12, wherein the step of transmitting write signals to a plurality of transducing heads is performed by a preamplifier circuit.

16. The method of claim 12, further comprising:
resynchronizing the parallel write control signals to account for jitter.
